(19) United States
(12) Patent Application Publication
(10) Pub. No.: US 2026/0012957 A1
(43) Pub. Date: Jan. 8, 2026

(54) METHOD AND DEVICE FOR BEAM MEASUREMENT AND BEAM CHANGE IN SIDELINK COMMUNICATION

(71) Applicants: HYUNDAI MOTOR COMPANY, Seoul (KR); KIA CORPORATION, Seoul (KR); GACHON UNIVERSITY INDUSTRY-ACADEMIC COOPERATION FOUNDATION, Gyeonggi-do (KR)

(72) Inventors: Ui Hyun Hong, Hwaseong-si, Gyeonggi-do (KR); Hyuk Min Son, Seoul (KR)

(73) Assignees: HYUNDAI MOTOR COMPANY, Seoul (KR); KIA CORPORATION, Seoul (KR); Gachon University Industry-Academic Cooperation Foundation, Seongnam-si, Gyeonggi-do (KR)

(21) Appl. No.: 18/881,724

(22) PCT Filed: Sep. 6, 2023
(86) PCT No.: PCT/KR2023/013329

§ 371 Date: Jan. 6, 2025

(30) Foreign Application Priority Data
Sep. 6, 2022 (KR) 10-2022-0112936

(51) Int. Cl. H04W 72/25; H04B 7/06

(52) U.S. Cl. CPC H04W 72/25; H04B 7/0626; H04B 7/06952

(57) ABSTRACT

Disclosed are a method for beam measurement and procedures for a TX UE and an RX UE for beam change in a sidelink. The method of a first UE disclosed herein may include transmitting a CSI request requesting a second UE to report CSI, wherein the CSI request is transmitted to the second UE through a different transmission beam for each of symbols in which a reference signal for the beam measurement is transmitted in a single SL slot.

### TECHNICAL FIELD

The present disclosure relates to a sidelink communication technique, and more particularly, to a technique for beam measurement and beam switching in sidelink communication.

### BACKGROUND ART

A communication network (e.g. 5G communication network or 6G communication network) is being developed to provide enhanced communication services compared to the existing communication networks (e.g. long term evolution (LTE), LTE-Advanced (LTE-A), etc.). The 5G communication network (e.g. New Radio (NR) communication network) can support frequency bands both below 6 GHz and above 6 GHz. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, no standard techniques currently have been developed for sidelink FR2 licensed band beam management. Additionally, a need for development of beam management in a sidelink FR2 licensed band has been mentioned in the NR sidelink evolution discussions during the 3GPP standard meetings for Rel. 18.

Therefore, there is a need for a method and apparatus for managing beams in an FR2 licensed band for sidelink communication.

### DISCLOSURE

### Technical Problem

The present disclosure is directed to providing a method and an apparatus for beam management of an FR2 licensed band in sidelink communication.

### Technical Solution

A method of a first user equipment (UE), according to an exemplary embodiment of the present disclosure, may comprise: transmitting, to a second UE, a channel state information (CSI) request requesting to report CSI; transmitting, to the second UE, a reference signal for beam measurement through different transmission beams in respective symbols where the reference signal is transmitted within one sidelink (SL) slot; receiving, from the second UE, a first CSI report including beam indexes based on an order of the respective symbols where the reference signal is transmitted and first CSI measurement information based on values obtained by measuring the reference signal in the respective symbols; determining a first transmission beam to be used for SL communication based on the first CSI report; and performing the SL communication with the second UE using the first transmission beam after a preset time offset.

The respective symbols where the reference signal is transmitted may include symbol(s) transmitting a Physical Sidelink Shared Channel (PSSCH), or include symbol(s) transmitting the PSSCH and symbol(s) transmitting a demodulation reference signal (DMRS).

The reference signal transmitted through the PSSCH may be a CSI-reference signal (CSI-RS).

When the CSI-RS is transmitted through two ports for each symbol, different beam indexes may be assigned to each symbol based on port numbers.

The method may further comprise: transmitting, to the second UE, sidelink-synchronization signal block(s) (S-SSB(s)) for CSI measurement through a plurality of beams based on the CSI request; and receiving, from the second UE, a second CSI report including second CSI measurement information based on measurement of the S-SSB(s) and beam indexes based on a transmission order of the plurality of beams, wherein in the determining of the first transmission beam, the first transmission beam may be determined by further considering the second CSI report.

The method may further comprise: transmitting, to the second UE, information of a CSI configuration window for limiting the S-SSB(s) used for the CSI measurement based on the CSI request, wherein the CSI configuration window may be configured as a predetermined time from the SL slot.

The method may further comprise: before performing the SL communication with the second UE using the first transmission beam, transmitting transmission beam indication information indicating the first transmission beam to the second UE.

The transmission beam indication information may be configured using a Transmission Configuration Indication (TCI) state.

The TCI state may be indicated by a Medium Access Control-Control Element (MAC-CE) or Radio Resource Control (RRC) message transmitted by the first UE to the second UE.

A method of a second user equipment (UE), according to an exemplary embodiment of the present disclosure, may comprise: receiving, from a first UE, a channel state information (CSI) request requesting to report CSI; receiving a reference signal for beam measurement transmitted through different beams within one sidelink (SL) slot based on the CSI request; transmitting, to the first UE, a first CSI report including beam indexes based on an order of respective symbols where the reference signal is transmitted and first CSI measurement information based on values obtained by measuring the reference signal in the respective symbols; and performing SL communication with the first UE through a first transmission beam after a preset time offset.

The respective symbols where the reference signal is transmitted may include symbol(s) transmitting a Physical Sidelink Shared Channel (PSSCH), or include symbol(s) transmitting the PSSCH and symbol(s) transmitting a demodulation reference signal (DMRS).

The reference signal transmitted through the PSSCH may be a CSI-reference signal (CSI-RS).

When the CSI-RS is transmitted through two ports for each symbol, different beam indexes may be assigned to each symbol based on port numbers.

The method may further comprise: receiving sidelink-synchronization signal block(s) (S-SSB(s)) for CSI measurement through a plurality of beams based on the CSI request; and transmitting, to the first UE, a second CSI report including second CSI measurement information based on measurement of the S-SSB(s) and beam indexes based on a transmission order of the plurality of beams.

The method may further comprise: receiving, from the first UE, information of a CSI configuration window for limiting the S-SSB(s) used for the CSI measurement based on the CSI request, wherein the CSI configuration window may be configured as a predetermined time from the SL slot.

The method may further comprise: before performing the SL communication using the first transmission beam, receiving transmission beam indication information indicating the first transmission beam.

The transmission beam indication information may be configured using a Transmission Configuration Indication (TCI) state.

The TCI state may be indicated by a Medium Access Control-Control Element (MAC-CE) or Radio Resource Control (RRC) message received from the first UE.

A first user equipment (UE), according to an exemplary embodiment of the present disclosure, may comprise: at least one processor, wherein the at least one processor causes the first UE to perform: transmitting, to a second UE, a channel state information (CSI) request requesting to report CSI; transmitting, to the second UE, a reference signal for beam measurement through different transmission beams in respective symbols where the reference signal is transmitted within one sidelink (SL) slot; receiving, from the second UE, a first CSI report including beam indexes based on an order of the respective symbols where the reference signal is transmitted and first CSI measurement information based on values obtained by measuring the reference signal in the respective symbols; determining a first transmission beam to be used for SL communication based on the first CSI report; and performing the SL communication with the second UE using the first transmission beam after a preset time offset.

The at least one processor may cause the first UE to perform: transmitting, to the second UE, sidelink-synchronization signal block(s) (S-SSB(s)) for CSI measurement through a plurality of beams based on the CSI request; and receiving, from the second UE, a second CSI report including second CSI measurement information based on measurement of the S-SSB(s) and beam indexes based on a transmission order of the plurality of beams, wherein in the determining of the first transmission beam, the first transmission beam may be determined by further considering the second CSI report.

### Advantageous Effects

The present disclosure provides a method and a UE for beam management in FR2 sidelink communication. Based on the sidelink communication methods according to the present disclosure, the optimal transmission beam can be identified using reference signals and/or synchronization signals used in sidelink communication, enabling beam switching without degrading sidelink communication efficiency.

### DESCRIPTION OF DRAWINGS

FIG. 1 is a conceptual diagram illustrating scenarios of Vehicle-to-Everything (V2X) communications.

FIG. 2 is a conceptual diagram illustrating a first exemplary embodiment of a communication system.

FIG. 3 is a conceptual diagram illustrating a first exemplary embodiment of a communication node constituting a communication system.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6 is a block diagram illustrating a first exemplary embodiment of a user plane protocol stack of a UE performing sidelink communication.

FIG. 7 is a block diagram illustrating a first exemplary embodiment of a control plane protocol stack of a UE performing sidelink communication.

FIG. 8 is a block diagram illustrating a second exemplary embodiment of a control plane protocol stack of a UE performing sidelink communication.

FIG. 9 is a conceptual diagram illustrating a first exemplary embodiment of a PSSCH/PSCCH slot structure with a normal CP.

FIG. 10 is a conceptual diagram illustrating a structure in which an SL slot and S-SSBs are transmitted within a resource pool.

FIG. 11 is a sequence chart illustrating a first exemplary embodiment of CSI measurement and CSI reporting using reference signals and S-SSBs.

FIG. 12 is a sequence chart illustrating a second exemplary embodiment of CSI measurement and CSI reporting using reference signals and S-SSBs.

FIG. 13 is a sequence chart illustrating a first exemplary embodiment of transmission beam switching based on CSI reporting.

FIG. 14 is a sequence chart illustrating a second exemplary embodiment of transmission beam switching based on CSI reporting.

FIG. 15 is a sequence chart illustrating a third exemplary embodiment of transmission beam switching based on CSI reporting.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re) transmission’ may refer to ‘transmission’, ‘retransmission’, or ‘transmission and retransmission’, ‘(re) configuration’ may refer to ‘configuration’, ‘reconfiguration’, or ‘configuration and reconfiguration’, ‘(re) connection’ may refer to ‘connection’, ‘reconnection’, or ‘connection and reconnection’, and ‘(re) access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g. transmission or reception of a signal) to be performed at a first communication node among communication nodes is described in exemplary embodiments, a corresponding second communication node may perform a method (e.g. reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g. master information block (MIB), system information block (SIB)) and/or an RRC message. The MAC signaling may refer to an operation of transmitting and receiving a MAC control element (CE). The PHY signaling may refer to an operation of transmitting and receiving control information (e.g. downlink control information (DCI), uplink control information (UCI), or sidelink control information (SCI)).

In the present disclosure, ‘configuration of an operation (e.g. transmission operation)’ may refer to signaling of configuration information (e.g. information elements, parameters) required for the operation and/or information indicating to perform the operation. ‘configuration of information elements (e.g. parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which exemplary embodiments are applied is not limited to that described below, and the exemplary embodiments may be applied to various communication networks (e.g. 4G communication networks, 5G communication networks, and/or 6G communication networks). Here, ‘communication network’ may be used interchangeably with a term ‘communication system’.

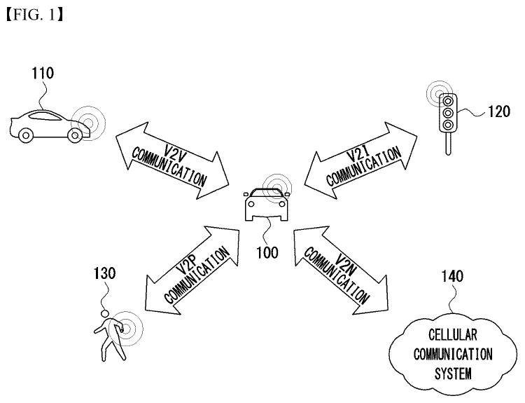

FIG. 1 is a conceptual diagram illustrating scenarios of Vehicle-to-Everything (V2X) communications.

As shown in FIG. 1, V2X communications may include Vehicle-to-Vehicle (V2V) communications, Vehicle-to-Infrastructure (V2I) communications, Vehicle-to-Pedestrian (V2P) communications, Vehicle-to-Network (V2N) communications, and the like. The V2X communications may be supported by a communication system (e.g. communication network) 140, and the V2X communications supported by the communication system 140 may be referred to as ‘Cellular-V2X (C-V2X) communications’. Here, the communication system 140 may include the 4G communication system (e.g. LTE communication system or LTE-A communication system), 5G communication system (e.g. NR communication system), and the like.

The V2V communications may include communications between a first vehicle 100 (e.g. a communication node located in the vehicle 100) and a second vehicle 110 (e.g. a communication node located in the vehicle 110). Various driving information such as velocity, heading, time, position, and the like may be exchanged between the vehicles 100 and 110 through the V2V communications. For example, autonomous driving (e.g. platooning) may be supported based on the driving information exchanged through the V2V communications. The V2V communications supported by the communication system 140 may be performed based on sidelink communication technologies (e.g. Proximity Based Services (ProSe) and Device-to-Device (D2D) communication technologies, and the like). In this case, the communications between the vehicles 100 and 110 may be performed using at least one sidelink channel.

The V2I communications may include communications between the first vehicle 100 and an infrastructure (e.g. road side unit (RSU)) 120 located on a roadside. The infrastructure 120 may include a traffic light or a street light which is located on the roadside. For example, when the V2I communications are performed, the communications may be performed between the communication node located in the first vehicle 100 and a communication node located in a traffic light. Traffic information, driving information, and the like may be exchanged between the first vehicle 100 and the infrastructure 120 through the V2I communications. The V2I communications supported by the communication system 140 may be performed based on sidelink communication technologies (e.g. ProSe and D2D communication technologies, and the like). In this case, the communications between the vehicle 100 and the infrastructure 120 may be performed using at least one sidelink channel.

The V2P communications may include communications between the first vehicle 100 (e.g. the communication node located in the vehicle 100) and a person 130 (e.g. a communication node carried by the person 130). The driving information of the first vehicle 100 and movement information of the person 130 such as velocity, heading, time, position, and the like may be exchanged between the vehicle 100 and the person 130 through the V2P communications. The communication node located in the vehicle 100 or the communication node carried by the person 130 may generate an alarm indicating a danger by judging a dangerous situation based on the obtained driving information and movement information. The V2P communications supported by the communication system 140 may be performed based on sidelink communication technologies (e.g. ProSe and D2D communication technologies, and the like). In this case, the communications between the communication node located in the vehicle 100 and the communication node carried by the person 130 may be performed using at least one sidelink channel.

The V2N communications may be communications between the first vehicle 100 (e.g. the communication node located in the vehicle 100) and the communication system (e.g. communication network) 140. The V2N communications may be performed based on the 4G communication technology (e.g. LTE or LTE-A specified as the 3GPP standards) or the 5G communication technology (e.g. NR specified as the 3GPP standards). Also, the V2N communications may be performed based on a Wireless Access in Vehicular Environments (WAVE) communication technology or a Wireless Local Area Network (WLAN) communication technology which is defined in Institute of Electrical and Electronics Engineers (IEEE) 802.11, a Wireless Personal Area Network (WPAN) communication technology defined in IEEE 802.15, or the like.

Meanwhile, the communication system 140 supporting the V2X communications may be configured as follows.

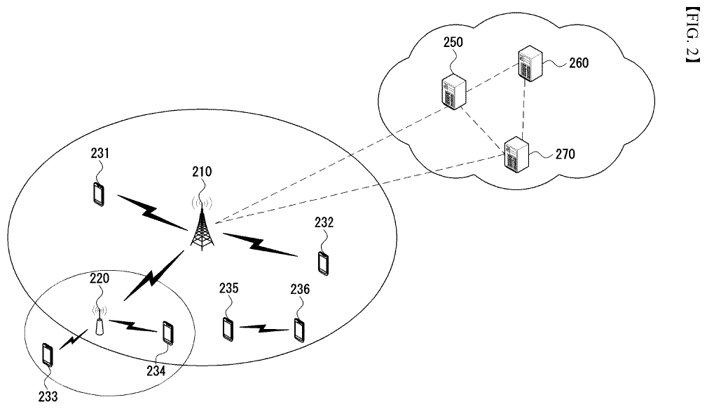

FIG. 2 is a conceptual diagram illustrating a first exemplary embodiment of a communication system.

As shown in FIG. 2, a communication system may include an access network, a core network, and the like. The access network may include a base station 210, a relay 220, user equipment (UEs) 231 through 236, and the like. The UEs 231 through 236 may include communication nodes located in the vehicles 100 and 110 of FIG. 1, the communication node located in the infrastructure 120 of FIG. 1, the communication node carried by the person 130 of FIG. 1, and the like. When the communication system supports the 4G communication technology, the core network may include a serving gateway (S-GW) 250, a packet data network (PDN) gateway (P-GW) 260, a mobility management entity (MME) 270, and the like.

When the communication system supports the 5G communication technology, the core network may include a user plane function (UPF) 250, a session management function (SMF) 260, an access and mobility management function (AMF) 270, and the like. Alternatively, when the communication system operates in a Non-Stand Alone (NSA) mode, the core network constituted by the S-GW 250, the P-GW 260, and the MME 270 may support the 5G communication technology as well as the 4G communication technology, and the core network constituted by the UPF 250, the SMF 260, and the AMF 270 may support the 4G communication technology as well as the 5G communication technology.

In addition, when the communication system supports a network slicing technique, the core network may be divided into a plurality of logical network slices. For example, a network slice supporting V2X communications (e.g. a V2V network slice, a V2I network slice, a V2P network slice, a V2N network slice, etc.) may be configured, and the V2X communications may be supported through the V2X network slices configured in the core network.

The communication nodes (e.g. base station, relay, UE, S-GW, P-GW, MME, UPF, SMF, AMF, etc.) constituting the communication system may perform communications by using at least one communication technology among a code division multiple access (CDMA) technology, a time division multiple access (TDMA) technology, a frequency division multiple access (FDMA) technology, an orthogonal frequency division multiplexing (OFDM) technology, a filtered OFDM technology, an orthogonal frequency division multiple access (OFDMA) technology, a single carrier FDMA (SC-FDMA) technology, a non-orthogonal multiple access (NOMA) technology, a generalized frequency division multiplexing (GFDM) technology, a filter bank multi-carrier (FBMC) technology, a universal filtered multi-carrier (UFMC) technology, and a space division multiple access (SDMA) technology.

The communication nodes (e.g. base station, relay, UE, S-GW, P-GW, MME, UPF, SMF, AMF, etc.) constituting the communication system may be configured as follows.

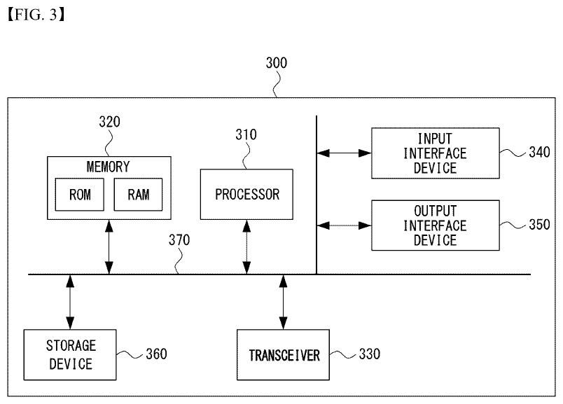

FIG. 3 is a conceptual diagram illustrating a first exemplary embodiment of a communication node constituting a communication system.

As shown in FIG. 3, a communication node 300 may comprise at least one processor 310, a memory 320, and a transceiver 330 connected to a network for performing communications. Also, the communication node 300 may further comprise an input interface device 340, an output interface device 350, a storage device 360, and the like. Each component included in the communication node 300 may communicate with each other as connected through a bus 370.

However, each of the components included in the communication node 300 may be connected to the processor 310 via a separate interface or a separate bus rather than the common bus 370. For example, the processor 310 may be connected to at least one of the memory 320, the transceiver 330, the input interface device 340, the output interface device 350, and the storage device 360 via a dedicated interface.

The processor 310 may execute at least one program command stored in at least one of the memory 320 and the storage device 360. The processor 310 may refer to a central processing unit (CPU), a graphics processing unit (GPU), or a dedicated processor on which methods in accordance with exemplary embodiments of the present disclosure are performed. Each of the memory 320 and the storage device 360 may include at least one of a volatile storage medium and a non-volatile storage medium. For example, the memory 320 may comprise at least one of read-only memory (ROM) and random access memory (RAM).

Referring again to FIG. 2, in the communication system, the base station 210 may form a macro cell or a small cell, and may be connected to the core network via an ideal backhaul or a non-ideal backhaul. The base station 210 may transmit signals received from the core network to the UEs 231 through 236 and the relay 220, and may transmit signals received from the UEs 231 through 236 and the relay 220 to the core network. The UEs 231, 232, 234, 235 and 236 may belong to a cell coverage of the base station 210. The UEs 231, 232, 234, 235 and 236 may be connected to the base station 210 by performing a connection establishment procedure with the base station 210. The UEs 231, 232, 234, 235 and 236 may communicate with the base station 210 after being connected to the base station 210.

The relay 220 may be connected to the base station 210 and may relay communications between the base station 210 and the UEs 233 and 234. That is, the relay 220 may transmit signals received from the base station 210 to the UEs 233 and 234, and may transmit signals received from the UEs 233 and 234 to the base station 210. The UE 234 may belong to both of the cell coverage of the base station 210 and the cell coverage of the relay 220, and the UE 233 may belong to the cell coverage of the relay 220. That is, the UE 233 may be located outside the cell coverage of the base station 210. The UEs 233 and 234 may be connected to the relay 220 by performing a connection establishment procedure with the relay 220. The UEs 233 and 234 may communicate with the relay 220 after being connected to the relay 220.

The base station 210 and the relay 220 may support multiple-input multiple-output (MIMO) technologies (e.g. single user (SU)-MIMO, multi-user (MU)-MIMO, massive MIMO, etc.), coordinated multipoint (COMP) communication technologies, carrier aggregation (CA) communication technologies, unlicensed band communication technologies (e.g. Licensed Assisted Access (LAA), enhanced LAA (eLAA), etc.), sidelink communication technologies (e.g. ProSe communication technology, D2D communication technology), or the like. The UEs 231, 232, 235 and 236 may perform operations corresponding to the base station 210 and operations supported by the base station 210. The UEs 233 and 234 may perform operations corresponding to the relays 220 and operations supported by the relays 220.

Here, the base station 210 may be referred to as a Node B (NB), evolved Node B (eNB), base transceiver station (BTS), radio remote head (RRH), transmission reception point (TRP), radio unit (RU), roadside unit (RSU), radio transceiver, access point, access node, or the like. The relay 220 may be referred to as a small base station, relay node, or the like. Each of the UEs 231 through 236 may be referred to as a terminal, access terminal, mobile terminal, station, subscriber station, mobile station, portable subscriber station, node, device, on-broad unit (OBU), or the like.

Meanwhile, communication nodes that perform communications in the communication network may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g. data unit) from a data source 410. The transmission processor 411 may receive control information from a controller 416. The control information may include at least one of system information, RRC configuration information (e.g. information configured by RRC signaling), MAC control information (e.g. MAC CE), or PHY control information (e.g. DCI, SCI).

The transmission processor 411 may generate data symbol(s) by performing processing operations (e.g. encoding operation, symbol mapping operation, etc.) on the data. The transmission processor 411 may generate control symbol(s) by performing processing operations (e.g. encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g. precoding operations) on the data symbol(s), control symbol(s), and/or synchronization/reference symbol(s). An output (e.g. symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g. de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g. data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g. precoding operations) on the data symbol(s), control symbol(s), and/or reference symbol(s). An output (e.g. symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g. de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

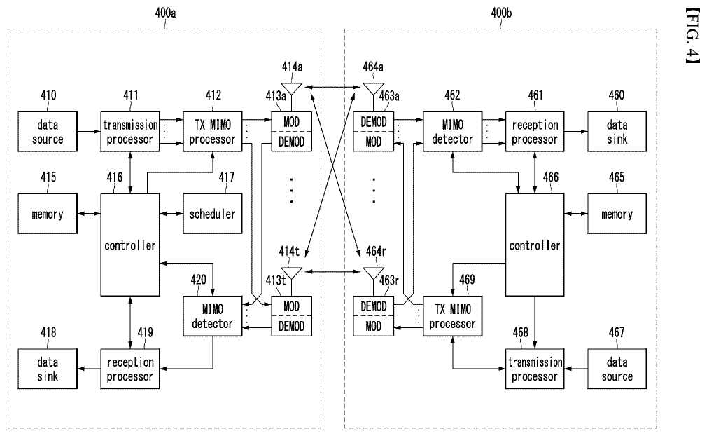

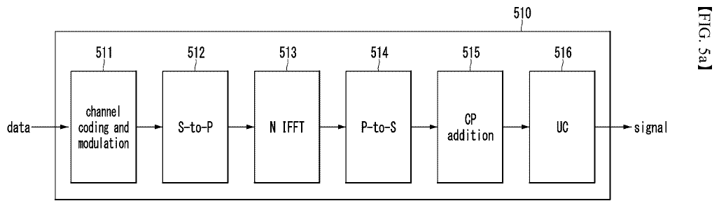

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g. components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, communications between the UEs 235 and 236 may be performed based on sidelink communication technology (e.g. ProSe communication technology, D2D communication technology). The sidelink communication may be performed based on a one-to-one scheme or a one-to-many scheme. When V2V communication is performed using sidelink communication technology, the UE 235 may refer to a communication node located in the first vehicle 100 of FIG. 1, and the UE 236 may refer to a communication node located in the second vehicle 110 of FIG. 1. When V2I communication is performed using sidelink communication technology, the UE 235 may refer to a communication node located in the first vehicle 100 of FIG. 1, and the UE 236 may refer to a communication node located in the infrastructure 120 of FIG. 1. When V2P communication is performed using sidelink communication technology, the UE 235 may refer to a communication node located in the first vehicle 100 of FIG. 1, and the UE 236 may refer to a communication node carried by the person 130.

The scenarios to which the sidelink communications are applied may be classified as shown below in Table 1 according to the positions of the UEs (e.g. the UEs 235 and 236) participating in the sidelink communications. For example, the scenario for the sidelink communications between the UEs 235 and 236 shown in FIG. 2 may be a sidelink communication scenario C.

TABLE 1

| Sidelink | | |
|---|---|---|
| Communication | | |
| Scenario | Position of UE 235 | Position of UE 236 |
| A | Out of coverage of | Out of coverage of |
| | base station 210 | base station 210 |
| B | In coverage of | Out of coverage of |
| | base station 210 | base station 210 |
| C | In coverage of base | In coverage of base |
| | station 210 | station 210 |
| D | In coverage of base | In coverage of other |
| | station 210 | base station |

Meanwhile, a user plane protocol stack of the UEs (e.g. the UEs 235 and 236) performing sidelink communications may be configured as follows.

FIG. 6 is a block diagram illustrating a first exemplary embodiment of a user plane protocol stack of a UE performing sidelink communication.

As shown in FIG. 6, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The user plane protocol stack of each of the UEs 235 and 236 may comprise a physical (PHY) layer, a medium access control (MAC) layer, a radio link control (RLC) layer, and a packet data convergence protocol (PDCP) layer.

The sidelink communications between the UEs 235 and 236 may be performed using a PC5 interface (e.g. PC5-U interface). A layer-2 identifier (ID) (e.g. a source layer-2 ID, a destination layer-2 ID) may be used for the sidelink communications, and the layer 2-ID may be an ID configured for the V2X communications. Also, in the sidelink communications, a hybrid automatic repeat request (HARQ) feedback operation may be supported, and an RLC acknowledged mode (RLC AM) or an RLC unacknowledged mode (RLC UM) may be supported.

Meanwhile, a control plane protocol stack of the UEs (e.g. the UEs 235 and 236) performing sidelink communications may be configured as follows.

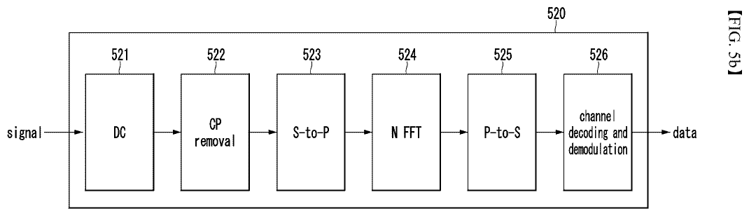

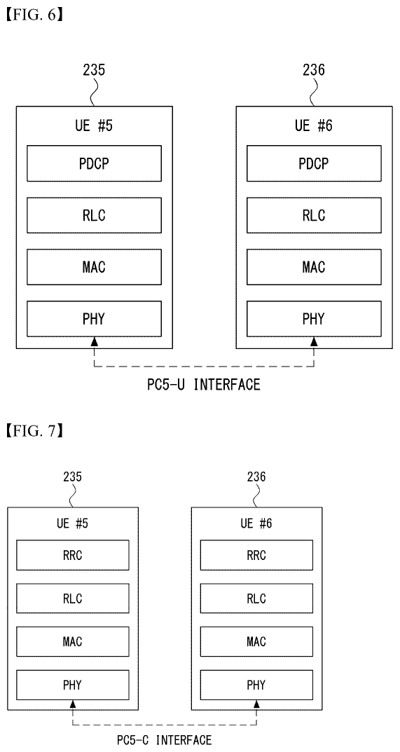

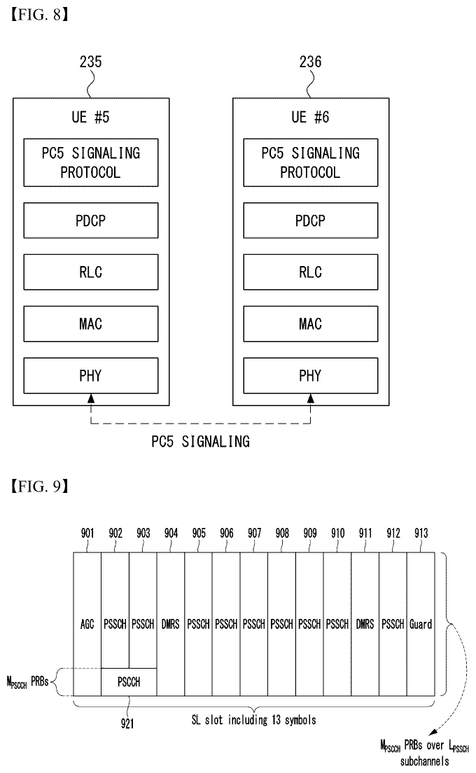

FIG. 7 is a block diagram illustrating a first exemplary embodiment of a control plane protocol stack of a UE performing sidelink communication, and FIG. 8 is a block diagram illustrating a second exemplary embodiment of a control plane protocol stack of a UE performing sidelink communication.

As shown in FIGS. 7 and 8, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The control plane protocol stack illustrated in FIG. 7 may be a control plane protocol stack for transmission and reception of broadcast information (e.g. Physical Sidelink Broadcast Channel (PSBCH)).

The control plane protocol stack shown in FIG. 7 may include a PHY layer, a MAC layer, an RLC layer, and a radio resource control (RRC) layer. The sidelink communications between the UEs 235 and 236 may be performed using a PC5 interface (e.g. PC5-C interface). The control plane protocol stack shown in FIG. 8 may be a control plane protocol stack for one-to-one sidelink communication. The control plane protocol stack shown in FIG. 8 may include a PHY layer, a MAC layer, an RLC layer, a PDCP layer, and a PC5 signaling protocol layer.

Meanwhile, channels used in the sidelink communications between the UEs 235 and 236 may include a Physical Sidelink Shared Channel (PSSCH), a Physical Sidelink Control Channel (PSCCH), a Physical Sidelink Discovery Channel (PSDCH), and a Physical Sidelink Broadcast Channel (PSBCH). The PSSCH may be used for transmitting and receiving sidelink data and may be configured in the UE (e.g. UE 235 or 236) by higher layer signaling. The PSCCH may be used for transmitting and receiving sidelink control information (SCI) and may also be configured in the UE (e.g. UE 235 or 236) by higher layer signaling.

The PSDCH may be used for a discovery procedure. For example, a discovery signal may be transmitted over the PSDCH. The PSBCH may be used for transmitting and receiving broadcast information (e.g. system information). Also, a demodulation reference signal (DM-RS), a synchronization signal, or the like may be used in the sidelink communications between the UEs 235 and 236. The synchronization signal may include a primary sidelink synchronization signal (PSSS) and a secondary sidelink synchronization signal (SSSS).

Meanwhile, a sidelink transmission mode (TM) may be classified into sidelink TMs 1 to 4 as shown below in Table 2.

TABLE 2

| Sidelink TM | Description |
|---|---|
| 1 | Transmission using resources scheduled by base station |
| 2 | UE autonomous transmission without scheduling of |
| | base station |
| 3 | Transmission using resources scheduled by base station |
| | in V2X communications |
| 4 | UE autonomous transmission without scheduling of base |
| | station in V2X communications |

When the sidelink TM 3 or 4 is supported, each of the UEs 235 and 236 may perform sidelink communications using a resource pool configured by the base station 210. The resource pool may be configured for each of the sidelink control information and the sidelink data.

The resource pool for the sidelink control information may be configured based on an RRC signaling procedure (e.g. a dedicated RRC signaling procedure, a broadcast RRC signaling procedure). The resource pool used for reception of the sidelink control information may be configured by a broadcast RRC signaling procedure. When the sidelink TM 3 is supported, the resource pool used for transmission of the sidelink control information may be configured by a dedicated RRC signaling procedure. In this case, the sidelink control information may be transmitted through resources scheduled by the base station 210 within the resource pool configured by the dedicated RRC signaling procedure. When the sidelink TM 4 is supported, the resource pool used for transmission of the sidelink control information may be configured by a dedicated RRC signaling procedure or a broadcast RRC signaling procedure. In this case, the sidelink control information may be transmitted through resources selected autonomously by the UE (e.g. UE 235 or 236) within the resource pool configured by the dedicated RRC signaling procedure or the broadcast RRC signaling procedure.

When the sidelink TM 3 is supported, the resource pool for transmitting and receiving sidelink data may not be configured. In this case, the sidelink data may be transmitted and received through resources scheduled by the base station 210. When the sidelink TM 4 is supported, the resource pool for transmitting and receiving sidelink data may be configured by a dedicated RRC signaling procedure or a broadcast RRC signaling procedure. In this case, the sidelink data may be transmitted and received through resources selected autonomously by the UE (e.g. UE 235 or 236) within the resource pool configured by the dedicated RRC signaling procedure or the broadcast RRC signaling procedure.

Hereinafter, sidelink communication methods will be described. Even when a method (e.g. transmission or reception of a signal) to be performed at a first communication node among communication nodes is described, a corresponding second communication node may perform a method (e.g. reception or transmission of the signal) corresponding to the method performed at the first communication node. That is, when an operation of a UE #1 (e.g. vehicle #1) is described, a UE #2 (e.g. vehicle #2) corresponding thereto may perform an operation corresponding to the operation of the UE #1. Conversely, when an operation of the UE #2 is described, the corresponding UE #1 may perform an operation corresponding to the operation of the UE #2. In exemplary embodiments described below, an operation of a vehicle may be an operation of a communication node located in the vehicle.

A sidelink signal may be a synchronization signal and a reference signal used for sidelink communication. For example, the synchronization signal may be a synchronization signal/physical broadcast channel (SS/PBCH) block, sidelink synchronization signal (SLSS), primary sidelink synchronization signal (PSSS), secondary sidelink synchronization signal (SSSS), or the like. The reference signal may be a channel state information-reference signal (CSI-RS), DM-RS, phase tracking-reference signal (PT-RS), cell-specific reference signal (CRS), sounding reference signal (SRS), discovery reference signal (DRS), or the like.

A sidelink channel may be a PSSCH, PSCCH, PSDCH, PSBCH, physical sidelink feedback channel (PSFCH), or the like. In addition, a sidelink channel may refer to a sidelink channel including a sidelink signal mapped to specific resources in the corresponding sidelink channel. The sidelink communication may support a broadcast service, a multicast service, a groupcast service, and a unicast service.

The base station may transmit system information (e.g. SIB12, SIB13, SIB14) and RRC messages including configuration information for sidelink communication (i.e. sidelink configuration information) to UE(s). The UE may receive the system information and RRC messages from the base station, identify the sidelink configuration information included in the system information and RRC messages, and perform sidelink communication based on the sidelink configuration information. The SIB12 may include sidelink communication/discovery configuration information. The SIB13 and SIB14 may include configuration information for V2X sidelink communication.

The sidelink communication may be performed within a SL bandwidth part (BWP). The base station may configure SL BWP(s) to the UE using higher layer signaling. The higher layer signaling may include SL-BWP-Config and/or SL-BWP-ConfigCommon. SL-BWP-Config may be used to configure a SL BWP for UE-specific sidelink communication. SL-BWP-ConfigCommon may be used to configure cell-specific configuration information.

Furthermore, the base station may configure resource pool(s) to the UE using higher layer signaling. The higher layer signaling may include SL-BWP-PoolConfig, SL-BWP-PoolConfigCommon, SL-BWP-DiscPoolConfig, and/or SL-BWP-DiscPoolConfigCommon. SL-BWP-PoolConfig may be used to configure a sidelink communication resource pool. SL-BWP-PoolConfigCommon may be used to configure a cell-specific sidelink communication resource pool. SL-BWP-DiscPoolConfig may be used to configure a resource pool dedicated to UE-specific sidelink discovery. SL-BWP-DiscPoolConfigCommon may be used to configure a resource pool dedicated to cell-specific sidelink discovery. The UE may perform sidelink communication within the resource pool configured by the base station.

The sidelink communication may support SL discontinuous reception (DRX) operations. The base station may transmit a higher layer message (e.g. SL-DRX-Config) including SL DRX-related parameter(s) to the UE. The UE may perform SL DRX operations based on SL-DRX-Config received from the base station. The sidelink communication may support inter-UE coordination operations. The base station may transmit a higher layer message (e.g. SL-InterUE-CoordinationConfig) including inter-UE coordination parameter(s) to the UE. The UE may perform inter-UE coordination operations based on SL-Inter UE-CoordinationConfig received from the base station.

The sidelink communication may be performed based on a single-SCI scheme or a multi-SCI scheme. When the single-SCI scheme is used, data transmission (e.g. sidelink data transmission, sidelink-shared channel (SL-SCH) transmission) may be performed based on one SCI (e.g. 1st-stage SCI). When the multi-SCI scheme is used, data transmission may be performed using two SCIs (e.g. 1st-stage SCI and 2nd-stage SCI). The SCI(s) may be transmitted on a PSCCH and/or a PSSCH. When the single-SCI scheme is used, the SCI (e.g. 1st-stage SCI) may be transmitted on a PSCCH. When the multi-SCI scheme is used, the 1st-stage SCI may be transmitted on a PSCCH, and the 2nd-stage SCI may be transmitted on the PSCCH or a PSSCH. The 1st-stage SCI may be referred to as ‘first-stage SCI’, and the 2nd-stage SCI may be referred to as ‘second-stage SCI’. A format of the first-stage SCI may include a SCI format 1-A, and a format of the second-stage SCI may include a SCI format 2-A, a SCI format 2-B, and a SCI format 2-C.

The SCI format 1-A may be used for scheduling a PSSCH and second-stage SCI. The SCI format 1-A may include at least one among priority information, frequency resource assignment information, time resource assignment information, resource reservation period information, demodulation reference signal (DMRS) pattern information, second-stage SCI format information, beta_offset indicator, number of DMRS ports, modulation and coding scheme (MCS) information, additional MCS table indicator, PSFCH overhead indicator, or conflict information receiver flag.

The SCI format 2-A may be used for decoding of a PSSCH. The SCI format 2-A may include at least one among a HARQ processor number, new data indicator (NDI), redundancy version (RV), source ID, destination ID, HARQ feedback enable/disable indicator, cast type indicator, or CSI request.

The SCI format 2-B may be used for decoding of a PSSCH. The SCI format 2-B may include at least one among a HARQ processor number, NDI, RV, source ID, destination ID, HARQ feedback enable/disable indicator, zone ID, or communication range requirement.

The SCI format 2-C may be used for decoding of a PSSCH. In addition, the SCI format 2-C may be used to provide or request inter-UE coordination information. The SCI format 2-C may include at least one among a HARQ processor number, NDI, RV, source ID, destination ID, HARQ feedback enable/disable indicator, CSI request, or providing/requesting indicator.

When a value of the providing/requesting indicator is set to 0, this may indicate that the SCI format 2-C is used to provide inter-UE coordination information. In this case, the SCI format 2-C may include at least one among resource combinations, first resource location, reference slot location, resource set type, or lowest subchannel indexes.

When a value of the providing/requesting indicator is set to 1, this may indicate that the SCI format 2-C is used to request inter-UE coordination information. In this case, the SCI format 2-C may include at least one among a priority, number of subchannels, resource reservation period, resource selection window location, resource set type, or padding bit(s).

Meanwhile, a beam management scheme on a Uu interface, which is a radio interface between a base station and a UE, will be described.

First, signals used for channel state information (CSI) measurement are CSI-RS sets or synchronization signal (SS) blocks.

Second, as a metric for CQI measurement for beams, a Layer 1 Reference Signal Received Power (L1-RSRP) is used.

Third, the maximum number of CSIs that can be reported per terminal is 4 (allowing CSI reporting for 4 beams).

Fourth, reporting information may utilize an L1-RSRP of the strongest beam (i.e. beam with the highest reception power) and difference values between the strongest beam and other three beams.

Fifth, CSI-RS transmission types are defined based on a CSI reporting type and a channel used for CSI reporting as follows.
1) Periodic: periodic+PUCCH
2) Semi-persistent: periodic+PUCCH or semi-persistent+PUSCH
3) Aperiodic: aperiodic (triggered by DCI with a CSI request field)+PUSCH

Sixth, beam adjustment needs to be performed for each of downlink transmission and reception beams. Only beam adjustment on downlink is performed if there is beam reciprocity between uplink and downlink.

The details which have been determined in 3GPP standard meetings regarding NR sidelink (SL) are as follows.

First, signals used for CSI measurement are CSI-RS sets.

Second, as a metric for CQI measurement, an L1-RSRP is used.

Third, up to 2-port CSI-RS can be used.

Fourth, CSI-RS transmission types are defined based on a CSI reporting type and a channel used for CSI reporting as follows.
1) Aperiodic: aperiodic (CSI reporting triggered by SCI 2-A or SCI 2-C)+MAC-CE (PSSCH)

All reference signals and physical channels referred to in the present disclosure are SL reference signals and physical channels. Hereinafter, two exemplary embodiments will be described.

As the first exemplary embodiment, methods for configuring reference signals for CSI measurement will be described. As the second exemplary embodiment, transmission beam switching methods will be described. In the present disclosure, the first exemplary embodiment and the second exemplary embodiment may be implemented independently or may be implemented together. Additionally, other exemplary embodiments not described in the present disclosure may be performed together with the two exemplary embodiments described in the present disclosure.

### First Exemplary Embodiment

In the first exemplary embodiment of the present disclosure, reference signal configuration schemes for CSI measurement will be described. For convenience of description in the present disclosure described below, CSI used for beam management is referred to as a beam index (BI) and beam quality information (BQI). The BI and BQI may be applied not only in the first exemplary embodiment but also in the second exemplary embodiment.

When reporting CSI, transmission of multiple BIs and BQIs may be possible, and in this case, the BQI may be configured as an RSRP or L1-RSRP for a corresponding beam. As another example, the BQI may be configured as a difference value between an RSRP or L1-RSRP of a reference beam and an RSRP or L1-RSRP of a measured beam other than the reference beam. The reference beam may be configured as a currently used beam or a beam currently with the best measured quality.

The signals used for beam management (BM) measurement may include at least one of a DMRS associated with a PSSCH, CSI-RS, and/or synchronization signal (SS). Additionally, the reference signals for BM may be configured using higher layer signaling such as RRC or MAC-CE, or may be configured through SCI.

When the reference signal (RSS) for BM are configured, BI mapping may be performed based on a time order of transmissions of the RSs for beam information measurement within a single sidelink (SL) slot. As another example, if two or more ports are used for transmission in the same time resource, the lower port number or higher port number may be mapped to the BI first. As yet another example, a common BI may be mapped to RSs transmitted using the same beam.

FIG. 9 is a conceptual diagram illustrating a first exemplary embodiment of a PSSCH/PSCCH slot structure with a normal CP.

As shown in FIG. 9, the first symbol of a SL slot may be allocated as an Auto Gain Control (AGC) symbol 901. A portion of the second and third symbols may be allocated as Physical Sidelink Control Channel (PSCCH) symbols 921. The remaining region of the second and third symbols may be allocated as Physical Sidelink Shared Channel (PSSCH) symbols 902 and 903. The fourth symbol may be allocated as a demodulation reference signal (DMRS) symbol 904. Subsequently, the fifth to tenth symbols may be allocated as PSSCH symbols 905 to 910. The eleventh symbol may again be allocated as a DMRS symbol 911. The twelfth symbol may be allocated as a PSSCH symbol 912, and the final thirteenth symbol may serve as a guard symbol 913.

As shown in FIG. 9, the number of PSCCH symbols may be pre-configured for each resource pool. Additionally, FIG. 9 illustrates a case where the PSCCH symbols 921 occupy M_{PSCCHM} PRBs in the frequency domain and are mapped to two symbols in the time domain. Furthermore, according to the example in FIG. 9, the PSSCH symbols 902 and 903 may be also transmitted in a time resource of the PSCCH symbols 921 where a PSCCH is transmitted.

When a single slot is configured as shown in FIG. 9, the PSSCH symbols 902 to 903, 905 to 910, and 912 may be transmitted in the second and third symbols, the fifth to tenth symbols, and the twelfth symbol. A CSI-RS for beam management or beam measurement purposes according to the present disclosure may be configured to be transmitted in a partial region within the PSSCH symbols. For example, the second and third symbols transmitted together with the PSCCH symbols 921 may be unsuitable for transmitting a CSI-RS for beam management or beam measurement purposes. However, even if the second and third symbols are unsuitable for transmitting a CSI-RS for beam management or beam measurement purposes, the CSI-RS for beam management or beam measurement purposes for a beam used for transmitting the PSCCH may still be configured to be transmitted.

In the present disclosure, a case is assumed where a CSI-RS for beam management or beam measurement purposes is transmitted in the fifth to tenth symbols and the twelfth symbol. Additionally, a case is assumed where only a CSI-RS is used for beam management or beam measurement. As another example, other signals such as a DMRS or synchronization signal (SS) may also be used.

In the example of FIG. 9, the respective CSI-RSs transmitted at the PSSCH symbol positions may be configured for transmission using a single port. When CSI-RSs are configured to be transmitted at the PSSCH symbol positions in the fifth to tenth symbols and the twelfth symbol, as shown in the example of FIG. 9, BIs may be mapped to beams transmitting the CSI-RSs, with indexes ranging from 1 to 7. In other words, the CSI-RSs transmitted at the PSSCH symbol positions in the fifth to tenth symbols and the twelfth symbol may be transmitted through different beams. Since the CSI-RSs are transmitted through different beams, BI mapping may be required to distinguish between the beams. In the present disclosure, an example of a mapping structure including identifiers for distinguishing BIs is illustrated in Table 3 below.

TABLE 3

| Symbol position within SL slot | Beam index (BI) | Identifier |
|---|---|---|
| Fifth symbol | 1 | 000 |
| Sixth symbol | 2 | 001 |
| Seventh symbol | 3 | 010 |
| Eighth symbol | 4 | 011 |
| Ninth symbol | 5 | 100 |
| Tenth symbol | 6 | 101 |
| Twelfth symbol | 7 | 110 |

Referring to Table 3, since there are seven BIs, each BI corresponding to each CSI-RS may be distinguished using three bits. Therefore, when using a mapping table as shown in Table 3, the RX UE may distinguish beams using the indexes corresponding to the respective BIs, and the distinguished beams may be indicated by the respective BIs. In other words, a BQI generated based on a result of measuring the CSI-RS for each beam may be reported to the TX UE during CSI reporting by being indicated by the corresponding BI.

Meanwhile, Table 3 illustrate a case where the CSI-RS is transmitted using a single port. If the CSI-RS is configured to be transmitted using two ports, the BI may need to be distinguished for each port. Therefore, to distinguish a BI corresponding to the CSI-RS by further using a port number, a mapping table such as Table 4 below may be used.

TABLE 4

| Symbol position | | Beam index | |
|---|---|---|---|
| within SL slot | Port number | (BI) | Identifier |
| Fifth symbol | port #0 | 1 | 0000 |
| Fifth symbol | port #1 | 2 | 0001 |
| Sixth symbol | port #0 | 3 | 0010 |
| Sixth symbol | port #1 | 4 | 0011 |
| Seventh symbol | port #0 | 5 | 0100 |
| Seventh symbol | port #1 | 6 | 0101 |
| Eighth symbol | port #0 | 7 | 0110 |
| Eighth symbol | port #1 | 8 | 0111 |
| Ninth symbol | port #0 | 9 | 1000 |
| Ninth symbol | port #1 | 10 | 1001 |
| Tenth symbol | port #0 | 11 | 1010 |
| Tenth symbol | port #1 | 12 | 1011 |
| Twelfth symbol | port #0 | 13 | 1100 |
| Twelfth symbol | port #1 | 14 | 1101 |

Table 4 may serve as an example where each symbol is configured to be transmitted using two ports. Each port is distinguished as a port #0 or port #1. Additionally, Table 4 corresponds to an example of BI mapping that prioritizes symbol positions and then prioritizes the lower port for each symbol. When two ports are allocated to each of the seven symbols in the above-described manner, each identifier may be expressed using four bits. Using the mapped identifiers, the BIs may be identified.

In addition, the example of Table 4, the identifiers mapped to the BIs may prioritize the symbol positions first and then priorities the lower port number for each symbol.

Table 4 is merely one example, and other various mappings may be also possible. For example, if priority is given to the port number, mapping may prioritize the port 0 of the fifth to tenth symbols and the twelfth symbol, followed by the port 1 for the same symbols. Specifically, the port #0 of the fifth symbol may remain mapped to the first BI with the identifier ‘0000’, while ‘0001’ may be mapped to the port #0 of the sixth symbol. Similarly, the port #0 of the twelfth symbol may be mapped to ‘0110’, and the port #1 of the fifth symbol may be mapped to ‘0111’.

Meanwhile, in FIG. 9, beam information (BI, BQI, etc.) measurement for the one-port CSI-RS may be configured at the DMRS symbol 904, which is the fourth symbol, as well as at the PSSCH symbols 905 to 910 and 912, which are the fifth to tenth symbols and the twelfth symbol. In this case, the BIs may be mapped as shown in Table 5 below.

TABLE 5

| Symbol position within SL slot | Beam index (BI) | Identifier |
|---|---|---|
| Forth symbol | 1 | 000 |
| Fifth symbol | 2 | 001 |
| Sixth symbol | 3 | 010 |
| Seventh symbol | 4 | 011 |
| Eighth symbol | 5 | 100 |
| Ninth symbol | 6 | 101 |
| Tenth symbol | 7 | 110 |
| Twelfth symbol | 8 | 111 |

Since beam information measurement is performed for the DMRS symbol 904, which is the fourth symbol, as well as the PSSCH symbols 905 to 910 and 912, which are the fifth to tenth symbols and the twelfth symbol, the BI mapping may need to be performed from the position of the DMRS symbol 904. In this case, the BI may be mapped starting from the DMRS symbol 904, as shown in Table 5, in accordance with the present disclosure.

If the DMRS and CSI-RS are configured to be transmitted using two ports as described in Table 4, the BI mapping in Table 5 may be performed based on Table 4. The cases where beam measurement is configured within the SL slot of FIG. 9 has been described. However, beam measurement may also be configured to be performed in an SS slot instead of the SL slot. If an SS slot is configured to be used in beam measurement, variations or extended forms of Tables 3 to 5 described above may be used. In other words, if SS slots are additionally used for beam measurement in addition to the resources of FIG. 9, transmission times, transmission resources, port numbers, and/or the like of signals configured for beam measurement may be mapped to the BIs.

When beam information measurement is configured to use SS slots in addition to SL slots as described above, the TX UE may indicate to the RX UE all or part of configuration information for synchronization signal block (SSB) transmission.

According to the current 3GPP Release 17 standards, sidelink SSBs (S-SSBs) are transmitted at a fixed position within a SL bandwidth part (BWP) with a periodicity of 160 ms. Additionally, multiple SSBs may be configured and transmitted within a corresponding period, and the S-SSB is not multiplexed with other SL physical channels.

Based on the currently determined specifications, the configuration information for SSB transmission for BM purposes may be indicated using a time offset value, as shown in FIG. 10, relative to a SSB transmission time based on an SL slot including CSI request information.

FIG. 10 is a conceptual diagram illustrating a structure in which an SL slot and S-SSBs are transmitted within a resource pool.

As shown in FIG. 10, an SL slot 1011 within a resource pool 1000 is illustrated. Additionally, S-SSBs 1021, 1022, and 1023, which are not multiplexed with other physical channels, are illustrated. In FIG. 10, a horizontal axis represents time. A time offset 1031 temporally separates the SL slot 1011 and the first S-SSB 1021. The time offset 1031 may be indicated using time units such as the number of slots, the number of symbols, or milliseconds (ms) from the SL slot 1011 to a transmission time of the first S-SSB 1021. The time offset 1031 may be indicated through SCI. Alternatively, the time offset 1031 may be indicated through higher-layer signaling such as MAC-CE or RRC. As another example, the time offset 1031 may be indicated through a combination of SCI and higher-layer signaling.

When information on the transmission of the first S-SSB 1021 is indicated by the SL slot 1011 in FIG. 10, beams used for transmitting the SS within the first S-SSB 1021 may be mapped to BIs in configuring the BIs.

The S-SSBs 1021, 1022, and 1023 in FIG. 10 may be repeatedly transmitted based on a preconfigured periodicity. Configuration information regarding the number of S-SSBs to be used for beam information measurement may be indicated by SCI within the SL slot. As another example, the configuration information regarding the number of S-SSBs to be used for beam information measurement may be configured through higher-layer signaling such as MAC-CE or RRC. As yet another example, the configuration information regarding the number of S-SSBs to be used for beam information measurement may be configured through a combination of SCI and higher-layer signaling.

Based on the above-described configuration, the beams used for transmitting SS within the S-SSBs used for BM may be mapped to the BIs together with other reference signals in a manner similar to Tables 3 to 5 described earlier.

In contrast to the examples described above, S-SSBs transmitted outside slots allocated as the resource pool used for SL communication by the TX UE and RX UE in FIG. 10 may be mapped to BIs separately from other reference signals. When the S-SSBs transmitted outside the slots allocated as the resource pool used for SL communication by the TX UE and RX UE are mapped separately from other reference signals, the BIs for the S-SSBs may be operated independently from BIs for other reference signals.

Additionally, in FIG. 10, the S-SSB 1023 and other S-SSBs (not shown in FIG. 10) transmitted after a latency bound 1041 configured for CSI reporting may be excluded from the signals used for beam information measurement or CSI measurement. Therefore, the S-SSBs excluded from beam information measurement or CSI measurement may also be excluded from BI mapping.

When configured as described above, the S-SSBs 1021 and 1022 transmitted within the latency bound 1041 configured for CSI reporting in FIG. 10 may be used for beam information measurement or CSI measurement, considering a processing time required for beam information measurement and reporting. For example, if a beam information reporting time, considering a processing time of the second S-SSB 1022, occurs after the latency bound 1041, the second S-SSB 1022 may be excluded from the signals used for beam information measurement or CSI measurement. If the second S-SSB 1022 is excluded from the signals used for beam information measurement or CSI measurement as described above, the S-SSB 1022 may also be excluded from BI mapping. Here, the processing time may be configured through the SCI within the SL slot. As another example, the processing time may be configured through higher-layer signaling such as MAC-CE or RRC. As another example, the processing time may be configured through a combination of SCI and higher-layer signaling.

In the example of FIG. 10, a CSI configuration window may be configured for beam information measurement or CSI measurement. When a CSI configuration window is configured, beam information measurement or CSI measurement operations may be performed based on the CSI configuration window. The CSI configuration window may be configured based on the latency bound 1041 described earlier, may be configured based on the processing time, or may be configured based on other factors.

Accordingly, the CSI configuration window may be configured as a specific time duration after the SL slot 1011 is transmitted in FIG. 10. In other words, the CSI configuration window may be configured based on a certain time, number of slots, or number of symbols starting from the SL slot 1011. When the CSI configuration window is configured as described above, the reference signals configured for beam information measurement or CSI measurement within the CSI configuration window may be configured to allow measurement. When the CSI configuration window is configured, reference signals outside the CSI configuration window (i.e. after the CSI configuration window) may be configured not to be used for beam information measurement or CSI measurement. Therefore, reference signals outside the CSI configuration window may also be excluded from BI mapping.

The CSI configuration window proposed in the present disclosure may be configured through the SCI transmitted within the SL slot 1011. As another example, the CSI configuration window proposed in the present disclosure may be configured through higher-layer signaling such as MAC-CE or RRC. As another example, the CSI configuration window proposed in the present disclosure may be configured through a combination of SCI transmitted within the SL slot 1011 and higher-layer signaling. The CSI configuration window may be preconfigured by the TX UE 1101, and informed to the RX UE 1102 in advance.

The time offset, latency bound, and CSI configuration window configurations described above with reference to FIG. 10 may be operated in an SL-specific or RP-specific manner.

In the description and example operations of Tables 3 to 5 and FIG. 10 described earlier, the CSI-RS has been discussed as a reference signal for beam information measurement. However, instead of the CSI-RS, a DMRS or SS may be used. These signals may be pre-configured by the TX UE, the RX UE, or the base station.

In the example of FIG. 10, CSI measurement and CSI reporting may be performed using the DMRS or CSI-RS, which are reference signals for beam information measurement transmitted within the SL slot 1011, and the SS transmitted through the S-SSBs 1021, 1022, and 1023, which are not reference signals. In other words, CSI measurement and CSI reporting may be performed based on pre-configured signals.

In this case, according to the configuration of the CSI measurement and CSI reporting scheme, CSI reporting may be performed after beam information measurement for the pre-configured signals. For example, the RX UE may perform CSI reporting after measuring the DMRS or CSI-RS within the SL slot 1011. Subsequently, the RX UE may perform another CSI reporting after beam information measurement using the S-SSBs 1021, 1022, and 1023.

In this case, the configuration and information for the pre-configured signals used for CSI measurement and CSI reporting, as well as for the two CSI reports, may be transmitted to the RX UE through SCI, PSSCH, or higher layer signaling such as a MAC-CE or RRC transmitted through a PSSCH, which is transmitted within the SL slot 1011.

Hereinafter, a CSI reporting procedure for a case where beam measurement is performed using reference signals such as CSI-RS and DMRS and synchronization signals such as S-SSB will be described.

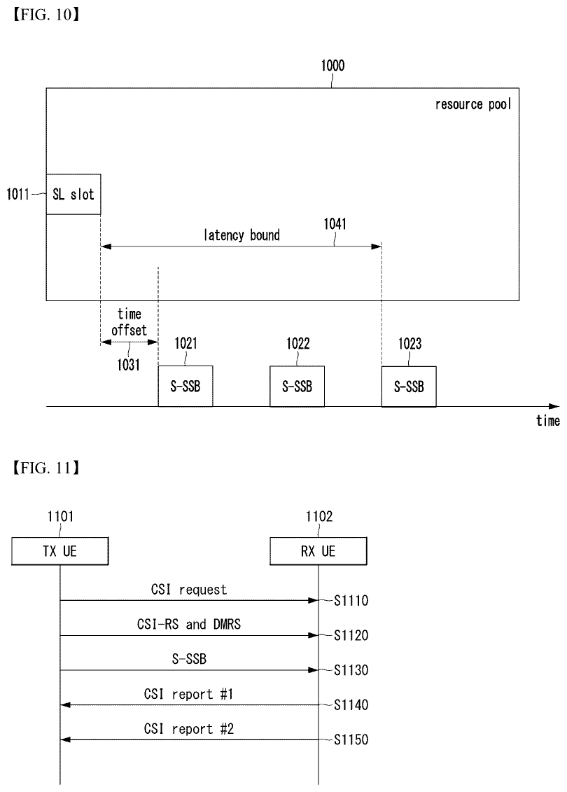

FIG. 11 is a sequence chart illustrating a first exemplary embodiment of CSI measurement and CSI reporting using reference signals and S-SSBs.

As shown in FIG. 11, a TX UE 1101 and an RX UE 1102 are illustrated, and each of the TX UE 1101 and the RX UE 1102 may be an entity performing a procedure of FIG. 11. Each of the TX UE 1101 and RX UE 1102 shown in FIG. 11 may be a communication node located in the vehicle 100 or 110, infrastructure 120, or communication node held by the person 130, as shown in FIG. 1. Additionally, each of the TX UE 1101 and RX UE 1102 may include at least part of or all of the components described with reference to FIG. 3 or may have additional components. Furthermore, each of the TX UE 1101 and RX UE 1102 may include at least part of the components described in FIGS. 4 to 8.

Referring to FIG. 11, the procedure of the TX UE 1101 and RX UE 1102 according to the present disclosure will be described.

In step S1110, the TX UE 1101 may transmit a CSI request to the RX UE 1102. The CSI request transmitted by the TX UE 1101 may be a message or signal for triggering a CSI report, specifically a request related to beam management (BM) as described in the present disclosure. Additionally, the CSI request transmitted by the TX UE 1101 to the RX UE 1102 may be indicated using first-stage SCI and/or second-stage SCI. As another example, the CSI request transmitted by the TX UE 1101 to the RX UE 1102 may be indicated through a MAC-CE. As yet another example, the CSI request transmitted by the TX UE 1101 to the RX UE 1102 may be indicated through a combination of two or more among first-stage SCI, second-stage SCI, and MAC-CE.

The CSI request transmitted by the TX UE 1101 in step S1110 may include information related to CSI reporting using the reference signals CSI-RS and/or DMRS, as well as CSI reporting using S-SSB, as described in FIGS. 9 and 10.

In step S1110, the RX UE 1102 may receive the CSI request from the TX UE 1101 based on one of the schemes described above.

In step S1120, the TX UE 1101 may transmit the CSI-RS and DMRS to the RX UE 1102. The CSI-RS transmitted by the TX UE 1101 may be transmitted in a (pre) defined time-frequency resource region or in a time-frequency resource region configured by the CSI request message. In other words, as described in FIGS. 9 and 10, the CSI-RS may be transmitted in symbols where a PSSCH is transmitted. Therefore, the respective symbols transmitting the CSI-RS may be transmitted through different corresponding beams. Additionally, the DMRS may be transmitted together with data when it is transmitted in the PSSCH symbols illustrated in FIG. 9. Since the DMRS is used to transmit the SL data, the DMRS may be transmitted only through a beam currently used for SL communication. As another example, the DMRS may also be transmitted based on the scheme described in Table 5 earlier.

Accordingly, when transmitting the CSI-RS to the RX UE 1102, the TX UE 1101 may transmit the CSI-RS using one or more transmission beams available to the TX UE 1101. If two or more transmission beams are used, the TX UE 1101 may transmit the CSI-RS by sweeping the transmission beams.

In step S1120, the RX UE 1102 may receive the CSI-RS and DMRS from the TX UE 1101 as described above. The RX UE 1102 may measure the CSI-RS and DMRS to generate CSI. If multiple beams are received, the RX UE 1102 may measure CSI for each of the beams.

In step S1130, the TX UE 1101 may transmit S-SSB(s) to the RX UE 1102. The S-SSB(s) transmitted by the TX UE 1101 may be transmitted in a (pre) defined time-frequency resource region or in a time-frequency resource region configured by the CSI request message and, as described in FIG. 10, are not multiplexed with other channels. Additionally, when transmitting the S-SSB(s) to the RX UE 1102, the TX UE 1101 may transmit the S-SSB(s) using multiple transmission beams available to the TX UE 1101. The SSs within the S-SSB, such as a sidelink primary synchronization signal (S-PSS) and sidelink secondary synchronization signal (S-SSS), may be transmitted through different beams. As another example, when multiple S-SSBs are transmitted, the respective S-SSBs may be transmitted through different beams. In this case, BIs corresponding to the beams and SSs within the S-SSBs, or BIs corresponding to the S-SSBs, may be mapped based on Tables 3 and 4 described earlier. Therefore, BI mapping for the symbols within the SL slot and BI mapping for the S-SSBs may differ. Alternatively, a single BI mapping table may be configured to cover both the symbols within the SL slot and the S-SSBs. Since multiple transmission beams are used, the TX UE 1101 may transmit the S-SSBs by sweeping the transmission beams.

In step S1130, the RX UE 1102 may receive the S-SSB(s) from the TX UE 1101 as described above. The RX UE 1102 may measure signal strength(s) of the S-SSB(s) to generate CSI. If multiple beams are received, the RX UE 1102 may measure CSI for each of the beams.

In step S1140, the RX UE 1102 may transmit a CSI report #1 to the TX UE 1101 through the sidelink. The CSI report #1 may be a CSI report generated based on the CSI measured using the CSI-RS and DMRS received in step S1120.

In step S1150, the RX UE 1102 may transmit a CSI report #2 to the TX UE 1101 through the sidelink. The CSI report #2 may be a CSI report generated based on the CSI measured using the S-SSBs received in step S1130.

According to the exemplary embodiment of FIG. 11 described above, the TX UE 1101 may transmit the CSI request and then transmit the reference signals such as CSI-RS and DMRS. Subsequently, the TX UE 1101 may additionally transmit the S-SSBs indicated by the CSI request, thereby enabling a BM request to be performed.

The RX UE 1102 may receive multiple types and instances of reference signals transmitted from the TX UE 1101 and perform CSI measurements on these resources. Additionally, the RX UE 1102 may perform CSI measurements using the synchronization signals received from the TX UE 1101. Accordingly, the RX UE 1102 may transmit the CSI report #1 to the TX UE 1101 as a CSI report for the reference signals and transmit the CSI report #2 to the TX UE 1101 as a CSI report for the synchronization signals. In other words, the CSI reporting may be performed twice.

Meanwhile, in FIG. 11 described above, the case where signals for beam measurement are transmitted through multiple beams for CSI measurement using different signals has been described. Specifically, the case where the CSI-RS and DMRS are transmitted as first signals for CSI measurement and the SSs of the S-SSBs are transmitted as other signals for CSI measurement has been described. However, a single type of signals may also be used for beam measurement. For example, only CSI-RS, only DMRS, or only SSs of the S-SSBs may be used for beam measurement. As another example, only CSI-RS and DMRS may be used.

Meanwhile, the exemplary embodiment described in FIG. 11 may be combined with at least one scheme of the second exemplary embodiment described below.

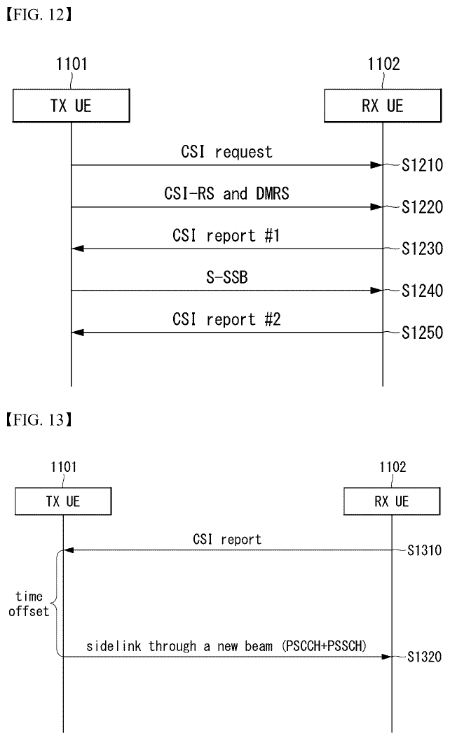

FIG. 12 is a sequence chart illustrating a second exemplary embodiment of CSI measurement and CSI reporting using reference signals and S-SSBs.

As shown in FIG. 12, the TX UE 1101 and the RX UE 1102 are illustrated, and each of the TX UE 1101 and the RX UE 1102 may be an entity performing a procedure of FIG. 12. Each of the TX UE 1101 and RX UE 1102 shown in FIG. 12 may be a communication node located in the vehicle 100 or 110, infrastructure 120, or communication node held by the person 130, as shown in FIG. 1. Additionally, each of the TX UE 1101 and RX UE 1102 may include at least part of or all of the components described with reference to FIG. 3 or may have additional components. Furthermore, each of the TX UE 1101 and RX UE 1102 may include at least part of the components described in FIGS. 4 to 8.

Referring to FIG. 12, the procedure of the TX UE 1101 and RX UE 1102 according to the present disclosure will be described.

In step S1210, the TX UE 1101 may transmit a CSI request to the RX UE 1102. The CSI request transmitted by the TX UE 1101 may be a message or signal for triggering a CSI report, specifically a request related to beam management (BM) as described in the present disclosure. Additionally, the CSI request transmitted by the TX UE 1101 to the RX UE 1102 may be indicated using first-stage SCI and/or second-stage SCI. As another example, the CSI request transmitted by the TX UE 1101 to the RX UE 1102 may be indicated through a MAC-CE. As yet another example, the CSI request transmitted by the TX UE 1101 to the RX UE 1102 may be indicated through a combination of two or more among first-stage SCI, second-stage SCI, and MAC-CE.

In step S1210, the CSI request transmitted by the TX UE 1101 may include information related to CSI reporting using the reference signals CSI-RS and DMRS, as well as CSI reporting using S-SSB, as described in FIGS. 9 and 10.

In step S1210, the RX UE 1102 may receive the CSI request from the TX UE 1101 based on one of the schemes described above.

In step S1220, the TX UE 1101 may transmit the CSI-RS and DMRS to the RX UE 1102. The CSI-RS transmitted by the TX UE 1101 may be transmitted in a (pre) defined time-frequency resource region or in a time-frequency resource region configured by the CSI request message. In other words, as described in FIGS. 9 and 10, the CSI-RS may be transmitted in symbols where a PSSCH is transmitted. Therefore, the respective symbol transmitting the CSI-RS may be transmitted through different corresponding beams. Additionally, the DMRS may be transmitted together with data when it is transmitted in the PSSCH symbols illustrated in FIG. 9. Since the DMRS is used to transmit the SL data, the DMRS may be transmitted only through a beam currently used for SL communication. As another example, the DMRS may also be transmitted based on the scheme described in Table 5 earlier.

Accordingly, when transmitting the CSI-RS to the RX UE 1102, the TX UE 1101 may transmit the CSI-RS using one or more transmission beams available to the TX UE 1101. If multiple transmission beams are used in transmitting the CSI-RS, the TX UE 1101 may transmit the CSI-RS by sweeping the transmission beams.

In step S1220, the RX UE 1102 may receive the CSI-RS and DMRS from the TX UE 1101 as described above. The RX UE 1102 may measure the CSI-RS and DMRS to generate CSI. If multiple beams are received, the RX UE 1102 may measure CSI for each of the beams.

In step S1230, the RX UE 1102 may transmit a CSI report #1 to the TX UE 1101 through the sidelink. The CSI report #1 may be a CSI report generated based on the CSI measured using the CSI-RS and DMRS received in step S1220. In this case, the CSI report #1 may include a BI corresponding to the measured signal strength or signal quality of each beam.

In step S1240, the TX UE 1101 may transmit S-SSB(s) to the RX UE 1102. The S-SSB(s) transmitted by the TX UE 1101 may be transmitted in a (pre) defined time-frequency resource region or in a time-frequency resource region configured by the CSI request message and, as described in FIG. 10, are not multiplexed with other physical channels.

Additionally, when transmitting the S-SSB(s) to the RX UE 1102, the TX UE 1101 may transmit the S-SSB(s) by using the transmission beams available to the TX UE 1101. The SSs within the S-SSB, such as sidelink primary synchronization signals (S-PSSs) and sidelink secondary synchronization signals (S-SSSs), may be transmitted through different beams. As another example, when multiple S-SSBs are transmitted, the respective S-SSBs may be transmitted through different beams. In this case, the BIs corresponding to the beams and SSs within the S-SSBs, or the BIs corresponding to the S-SSBs, may be mapped based on Tables 3 through 4 described earlier. Therefore, the BI mapping for the symbols within the SL slot and the BI mapping for the S-SSBs may differ. Alternatively, a single BI mapping table may be configured to cover both the symbols within the SL slot and the S-SSBs. Since multiple transmission beams are used, the TX UE 1101 may transmit the S-SSBs by sweeping the transmission beams.

In step S1240, the RX UE 1102 may receive the S-SSB(s) from the TX UE 1101 as described above. The RX UE 1102 may measure signal strength(s) of the S-SSB(s) to generate CSI. If multiple beams are received, the RX UE 1102 may measure CSI for each of the beams.

In step S1250, the RX UE 1102 may transmit a CSI report #2 to the TX UE 1101 through the sidelink. The CSI report #2 may be a CSI report generated based on the CSI measured using the S-SSBs received in step S1240.

The exemplary embodiment of FIG. 12 described above may have a similar structure to the exemplary embodiment of FIG. 11 described earlier. However, a difference lies in the times of transmitting the CSI report #1 and CSI report #2. In other words, FIG. 11 describes a procedure in which CSI reporting is performed after receiving both the reference signals and synchronization signals required for CSI reporting. On the other hand, FIG. 12 describes a procedure in which CSI reporting for the reference signals is performed immediately upon their reception, followed by CSI reporting for the synchronization signals upon their reception.

In the exemplary embodiments of FIG. 11 and FIG. 12 described above, the cases where CSI reporting is performed using the CSI-RS, DMRS, and SS of the S-SSB have been described as examples. However, in addition to the signals described above, other types of signals that are preconfigured between the TX UE 1101 and RX UE 1102 and can be used as a reference may also be used as signals for CSI reporting based on the schemes described in the present disclosure.

Additionally, the present disclosure may be understood as having described the case where two CSI reporting groups are configured. Specifically, the CSI-RS and DMRS may form one CSI reporting group, while the SSs of the S-SSB(s) may form the other CSI reporting group. Therefore, if other types of reference signals are used, the reporting groups may be extended. It may be also possible to configure the other types of reference signals to be processed together in at least one of the aforementioned groups. In the above-described manner, the reporting groups may not only take the forms illustrated in FIGS. 11 and 12 but also be modified or extended in various manners based on the descriptions provided above.

Meanwhile, based on the examples of FIGS. 9 to 12 and Tables 3 to 5, the preconfigured signals (e.g. CSI-RS, DMRS, SS) used for reception beam switching may be excluded from BI mapping. Additionally, after measuring the preconfigured signals (e.g. CSI-RS, DMRS, SS) for reception beam switching, the measured information may be excluded from CSI report information.

Whether the transmission of preconfigured signals is for reception beam switching purposes may be explicitly or implicitly indicated through the CSI request, measurement, and reporting configuration information provided through a combination of higher-layer signaling such as MAC-CE and RRC and SCI.

Meanwhile, in FIG. 12 described above, the case where signals for beam measurement are transmitted through multiple beams for CSI measurement using different signals has been described. Specifically, the case where the first signals for CSI measurement, such as CSI-RS and DMRS, are transmitted and other signals for CSI measurement, such as the SS of the S-SSB, are transmitted has been described.

However, a single type of signals may also be used for beam measurement. For example, only CSI-RS, only DMRS, or only the SSs of the S-SSB may be used for beam measurement. As another example, only CSI-RS and DMRS may be used.

Meanwhile, the exemplary embodiment described in FIG. 12 may be combined with at least one scheme of the second exemplary embodiment described below.

### Second Exemplary Embodiment

The second exemplary embodiment of the present disclosure describes a transmission beam switching method. For convenience of description, it is assumed that multiple BIs and BQIs corresponding to the respective BIs are reported. Additionally, to perform transmission beam switching to a beam other than a currently used beam, transmission beam switching may be performed based on the operations described below.

In the second exemplary embodiment described below, two specific methods, referred to as Beam Switching Method #1 and Beam Switching Method #2, will be described. However, the present disclosure is not limited to the beam switching methods described below. Variations of the beam switching methods described in the present disclosure and combinations with other exemplary embodiments may also be used. Specifically, at least one of the beam switching methods described in the second exemplary embodiment may be used in conjunction with the first exemplary embodiment described earlier.

### (1) Beam Switching Method #1

FIG. 13 is a sequence chart illustrating a first exemplary embodiment of transmission beam switching based on CSI reporting.

As shown in FIG. 13, the TX UE 1101 and the RX UE 1102 are illustrated, and each of the TX UE 1101 and the RX UE 1102 may be an entity performing a procedure of FIG. 13. Each of the TX UE 1101 and RX UE 1102 shown in FIG. 13 may be a communication node located in the vehicle 100 or 110, infrastructure 120, or communication node held by the person 130, as shown in FIG. 1. Additionally, each of the TX UE 1101 and RX UE 1102 may include at least part of or all of the components described with reference to FIG. 3 or may have additional components. Furthermore, each of the TX UE 1101 and RX UE 1102 may include at least part of the components described in FIGS. 4 to 8.

Referring to FIG. 13, the procedure of the TX UE 1101 and RX UE 1102 according to the present disclosure will be described.

In step S1310, the RX UE 1102 may transmit a CSI report to the TX UE 1101 through the sidelink. Here, the CSI report may include CSI and may be transmitted using a PSSCH or a MAC-CE of the PSSCH transmitted by the RX UE 1102 to the TX UE 1101.

The transmission of the CSI report from the RX UE 1102 to the TX UE 1101 in step S1310 may occur based on the scheme described in FIG. 11 and FIG. 12, or other schemes, and may mean that the TX UE 1101 has already transmitted preconfigured signals to the RX UE 1102 that enable the CSI reporting. In other words, prior to step S1310 in FIG. 13, the TX UE 1101 may have transmitted at least one preconfigured signal such as reference signals or SSs with S-SSB(s). Accordingly, the RX UE 1102 may transmit the CSI report based on the signals received from the TX UE 1101.

If the TX UE 1101 has transmitted preconfigured signals using multiple beams, the RX UE 1102 may report CSI for each of the multiple beams. As another example, if the TX UE 1101 has transmitted preconfigured signals using multiple beams, the RX UE 1102 may report CSI for only a beam with the highest quality. As another example, if the TX UE 1101 has transmitted preconfigured signals using multiple beams, the RX UE 1102 may include information on a beam with the highest quality and transmit information on a difference relative to the beam with the highest quality for each of the remaining beams.

Here, the beam with the highest quality may be determined as either a beam with the highest received signal received power (RSRP) or a beam with the highest Layer 1 (L1)-RSRP.

In step S1310, the TX UE 1101 may receive the CSI report from the RX UE 1102 through a PSSCH or a MAC-CE of the PSSCH.

The TX UE 1101 may determine whether to switch a transmission beam used for SL communication based on the CSI report received from the RX UE 1102. The TX UE 1101 may select a beam with the best BQI among the beams reported by the RX UE 1102 as a beam to be switched to. The selected beam may be either a beam currently in use for communication or a new beam.

In the example of FIG. 13, the transmission beam used for SL communication may be switched to a new transmission beam based on the CSI report received by the TX UE 1101 from the RX UE 1102.

Even if it is determined to switch the transmission beam used for SL communication, the TX UE 1101 may not switch the SL transmission beam during a time offset. In the case of applying a time offset, the TX UE 1101 may notify the RX UE 1102 of the selected beam and acquire time synchronization to ensure that SL communication is performed based on the beam switching at the RX UE 1102.

After the time offset elapses, the TX UE 1101 may transmit SL control information and SL data to the RX UE 1102 in step S1320 through the sidelink by using the new beam. The SL control information may be transmitted through a PSCCH, and the SL data may be transmitted through a PSSCH.

The time offset may be configured through SCI. As another example, the time offset may be configured through higher-layer signaling such as MAC-CE or RRC. As another example, the time offset may be configured based on a combination of higher-layer signaling and SCI.

Meanwhile, when applying the procedure of FIG. 13, there may be a possibility that transmission beam switching may occur too frequently. If transmission beam switching occurs frequently, it may cause interference with other nearby UEs. Additionally, since the procedure for transmission beam switching needs to be continuously performed, power consumption of the TX UE 1101 and RX UE 1102 may increase significantly. Furthermore, as resources are consumed for the transmission beam switching procedure, resource utilization efficiency of SL communication may decrease, and SL communication may not be performed smoothly.

To prevent frequent transmission beam switching, the TX UE 1101 may determine whether to switch the beam using a preconfigured threshold based on the CSI report received from the RX UE 1102.

Before describing the threshold, CQIs or BQIs included in the CSI report for transmission beam switching will be further described. The CSI report received by the TX UE 1101 from the RX UE 1102 may directly or indirectly include CQIs or BQIs for multiple beams. The case where the CSI report indirectly includes the CQIs or BQIs for multiple beams may correspond to a case where RSRPs or L1-RSRPs for all beams are not included. In other words, the CSI report may include an RSRP of a beam with the highest RSRP and report only a difference between the RSRP of the beam with the highest RSRP and an RSRP of each of other beams.

Based on the CQIs or BQIs for multiple beams included in the CSI report and the threshold, whether to switch the transmission beam may be determined. In other words, if the transmission beam currently used for SL communication is not the beam with the highest RSRP, and a difference between the RSRP of the current transmission beam and the beam with the highest RSRP is below the threshold, the current transmission beam may continue to be used for SL communication. On the other hand, if the difference between the RSRP of the current transmission beam and the beam with the highest RSRP exceeds the threshold, the transmission beam may be switched to the beam with the highest RSRP.

The threshold may be set as various values. For example, an optimal value may be experimentally determined based on the mentioned factors. Alternatively, the threshold may be set based on an anticipated SL communication efficiency.

If the threshold is set to zero, the transmission beam may always be switched to the beam with the highest RSRP after the time offset elapses. In other words, once the configured time offset has elapsed, SL communication may be performed using the beam with the highest RSRP reported by the RX UE 1102 to the TX UE 1101.

FIG. 13 illustrates the example using the time offset. However, operation without a time offset may also be possible. For example, SL communication may be performed through a transmission beam determined based on the CSI report starting from a SL slot transmitted after the CSI report. In this case, the TX UE 1101 may indicate to the RX UE 1102 that the beam has been switched due to specific conditions using SCI or a MAC-CE of a PSSCH.

If one bit is used to indicate whether the transmission beam has been switched, a toggling bit may indicate whether the beam switching has been applied. For example, if the previously used beam is maintained, ‘0’ may be indicated, and if a different beam from the previously used beam is used, ‘1’ may be indicated.

The various beam switching operations described above are examples of automatic switching to a better beam under specific conditions. However, the beam switching scheme may also be controlled by preconfiguring an indication on whether the TX UE 1101 is to perform beam switching and notifying the indication to the RX UE 1102.

For example, the TX UE 1101 may use 1-bit information to indicate whether to perform transmission beam switching. For convenience of description, the 1-bit information indicating whether to perform transmission beam switching will be referred to as ‘transmission beam switching indication information’.

If the TX UE 1101 does not allow beam switching, the TX UE 1101 may set the transmission beam switching indication information to ‘0’ and transmit it to the RX UE 1102. The transmission beam switching indication information may be transmitted through SCI or through a MAC-CE of a PSSCH. When the transmission beam switching indication information is set to ‘0’, the RX UE 1102 may not expect the TX UE 1101 to switch the transmission beam. Additionally, the TX UE 1101 may not switch the transmission beam until the transmission beam switching indication information set differently is transmitted to the RX UE 1102. When the transmission beam switching indication information indicates that beam switching is not allowed, the TX UE 1101 may not switch the transmission beam, even if the TX UE 1101 receives a CSI report from the RX UE 1102. In other words, the TX UE 1101 may maintain the transmission beam currently used for SL communication with the RX UE 1102.

On the other hand, if the TX UE 1101 allows beam switching, the TX UE 1101 may set the transmission beam switching indication information to ‘1’ and transmit it to the RX UE 1102. The transmission beam switching indication information may also be transmitted through SCI or through a MAC-CE of a PSSCH. If the transmission beam switching indication information is set to ‘1’, the RX UE 1102 may recognize, based on the transmission beam switching indication information, that the TX UE 1101 may switch the transmission beam. Therefore, the TX UE 1101 may determine whether to switch the transmission beam based on the CSI report received from the RX UE 1102. In other words, as described above, the TX UE 1101 may use a threshold to determine whether to switch the transmission beam. If it is determined to switch the transmission beam, the TX UE 1101 may transmit SL control information and SL data through the switched beam in SL communication after a time offset elapses.

Configuration information such as the time offset and the threshold for beam quality described above may be operated in an SL-specific or RP-specific manner. Additionally, the time offset may be indicated in time units such as the number of SL slots, the number of symbols, or milliseconds (ms).

### (2) Beam Switching Method #2

In Beam Switching Method #2 described below, a specific beam for SL communication after a CSI report may be indicated as a transmission beam, and SL communication may then be performed using the indicated beam starting from a SL slot transmitted thereafter or a SL slot transmitted after a preset time offset.

FIG. 14 is a sequence chart illustrating a second exemplary embodiment of transmission beam switching based on CSI reporting.

As shown in FIG. 14, the TX UE 1101 and the RX UE 1102 are illustrated, and each of the TX UE 1101 and the RX UE 1102 may be an entity performing a procedure of FIG. 14. Each of the TX UE 1101 and RX UE 1102 shown in FIG. 14 may be a communication node located in the vehicle 100 or 110, infrastructure 120, or communication node held by the person 130, as shown in FIG. 1. Additionally, each of the TX UE 1101 and RX UE 1102 may include at least part of or all of the components described with reference to FIG. 3 or may have additional components. Furthermore, each of the TX UE 1101 and RX UE 1102 may include at least part of the components described in FIGS. 4 to 8.

Referring to FIG. 14, the procedure of the TX UE 1101 and RX UE 1102 according to the present disclosure will be described.

In step S1410, the RX UE 1102 may transmit a CSI report to the TX UE 1101 through the sidelink. Here, the CSI report may include CSI and may be transmitted using a PSSCH or a MAC-CE of the PSSCH transmitted by the RX UE 1102 to the TX UE 1101.

The transmission of the CSI report from the RX UE 1102 to the TX UE 1101 in step S1410 may mean that the TX UE 1101 has already transmitted preconfigured signals to the RX UE 1102 that enable the CSI reporting as described in FIGS. 11 to 13. In other words, prior to step S1410 in FIG. 14, the TX UE 1101 may have transmitted at least one preconfigured signal such as reference signals or SSs with S-SSB(s). Accordingly, the RX UE 1102 may transmit the CSI report based on the signals received from the TX UE 1101.

If the TX UE 1101 has transmitted preconfigured signals using multiple beams, the RX UE 1102 may report CSI for each of the multiple beams. As another example, if the TX UE 1101 has transmitted preconfigured signals using multiple beams, the RX UE 1102 may report CSI for only a beam with the highest quality. As another example, if the TX UE 1101 has transmitted preconfigured signals using multiple beams, the RX UE 1102 may transmit information on a beam with the highest quality and transmit information on a difference relative to the beam with the highest quality for each of the remaining beams.

Here, the beam with the highest quality may be determined as either a beam with the highest received signal received power (RSRP) or a beam with the highest Layer 1 (L1)-RSRP.

In step S1410, the TX UE 1101 may receive the CSI report from the RX UE 1102 through a PSSCH or a MAC-CE of the PSSCH.

The TX UE 1101 may determine whether to switch a transmission beam used for SL communication based on the CSI report received from the RX UE 1102. The TX UE 1101 may select a beam with the best BQI among the beams reported by the RX UE 1102 as a beam to be switched to. The selected beam may be either a beam currently in use for communication or a new beam.

In the example of FIG. 14, the transmission beam used for SL communication may be switched to a new transmission beam based on the CSI report received by the TX UE 1101 from the RX UE 1102.

In step S1420, the TX UE 1101 may transmit information on the transmission beam to be switched to the RX UE 1102 after completing beam selection. For example, the information on the transmission beam to be switched may be indicated through a PSCCH and/or PSSCH. As another method, the information on the transmission beam to be switched may be indicated through higher-layer signaling such as a MAC-CE of a PSSCH or RRC signaling. As another example, the information on the transmission beam to be switched may be indicated through a combination of higher-layer signaling and a PSCCH and/or PSSCH.

Although FIG. 14 does not explicitly illustrate a step where the information on the transmission beam is transmitted, the TX UE 1101 may transmit SL control information and/or SL data to the RX UE 1102 through the transmission beam indicated in step S1420.

When indicating the transmission beam in step S1420 in the example of FIG. 14, the transmission beam indication may use the BI used during the CSI reporting. Since the BI mapping scheme has already been described in the first exemplary embodiment, redundant description will be omitted.

Additionally, in step S1420, the transmission beam may be indicated through a Transmission Configuration Indication (TCI). In SL communication, since a scheduling offset between a PSCCH and PSSCH is ‘0’, the two physical channels may be assumed to be spatially QCLed. Therefore, switching to a specific beam may be indicated by specifying a particular TCI state among TCI states configured between the TX UE 1101 and the RX UE 1102. The TCI states configured between the TX UE 1101 and the RX UE 1102 may be configured through higher-layer signaling such as MAC-CE or RRC.

Additionally, the TCI state may be indicated using multiple bits through SCI or a MAC-CE of a PSSCH. Subsequently, the TX UE 1101 may perform SL communication using the indicated transmission beam.

In the procedure of FIG. 14, each TCI state may finally be explicitly or implicitly mapped to a specific transmission beam. For example, if three bits are used to indicate the TCI state, one of up to eight transmission beams may be specified. As another scheme for indicating the transmission beam, a list of beam information, as shown in Table 6 below, may be generated and shared with the RX UE 1102 to indicate the transmission beam.

TABLE 6

| Beam identifier | BQI information | QCLed reference signal |
|---|---|---|
| 000 | X1 | RS ID#1 |
| 001 | X2 | RS ID#2 |
| 010 | X3 | RS ID#3 |
| 011 | X4 | RS ID#4 |
| 100 | X5 | RS ID#5 |
| 101 | X6 | RS ID#6 |
| 110 | X7 | RS ID#7 |
| 111 | X8 | RS ID#8 |

The example in Table 6 represents a list generated for transmission beam indication using three bits of information, which will be referred to as a ‘transmission beam indication list’ for convenience of description below.

If the transmission beam indication list as in Table 6 is shared between the TX UE 1101 and the RX UE 1102, it allows for the management of up to eight beams. The eight beams may represent all the beams operated by the TX UE 1101. Alternatively, the eight beams may be a subset of selected beams among the total beams operated by the TX UE 1101. In this case, the selected beams may be updated during the beam management process. If the selected beams are updated, a new transmission beam indication list according to the present disclosure may need to be generated, and the updated list may need to be shared between the TX UE 1101 and the RX UE 1102.

The information in the transmission beam indication list exemplified in Table 6 may be updated after beam reporting and transmitted by the TX UE 1101 to the RX UE 1102 through a MAC-CE of a PSSCH. In the example of FIG. 14, during PSCCH and PSSCH transmission for transmission beam indication, i.e., in step S1420, the updated transmission beam indication list may be transmitted through a MAC-CE of a PSSCH.

Since the beam identifiers in the transmission beam indication list exemplified in Table 6 are not absolute beam IDs, mapping information for actual beams corresponding to the beam identifiers may need to be preconfigured between the TX UE 1101 and the RX UE 1102. The mapping information may be configured through QCLed reference signals. The QCLed reference signals may be signals transmitted by the TX UE 1101 for beam information measurement. Depending on the configuration, the QCLed reference signals may be CSI-RSs and/or DMRSs, or they may include preconfigured non-reference signals such as SSs of S-SSB(s) described earlier.

By mapping IDs to the preconfigured signals and updating the list in the above-described manner, the TX UE 1101 and RX UE 1102 may continuously manage up to eight beams. Based on this, the TX UE 1101 may indicate a specific beam among the eight beams for use in SL communication. In this case, the indication may be performed using the beam identifiers exemplified in Table 6 above.

The entity responsible for generating the transmission beam indication list in Table 6, as described above, may be the TX UE 1101. In other words, based on the procedure described in FIG. 14, after the CSI reporting in step S1410, the TX UE 1101 may generate the transmission beam indication list such as Table 6. The TX UE 1101 may then transmit the transmission beam indication list to the RX UE 1102 through a MAC-CE of a PSSCH.

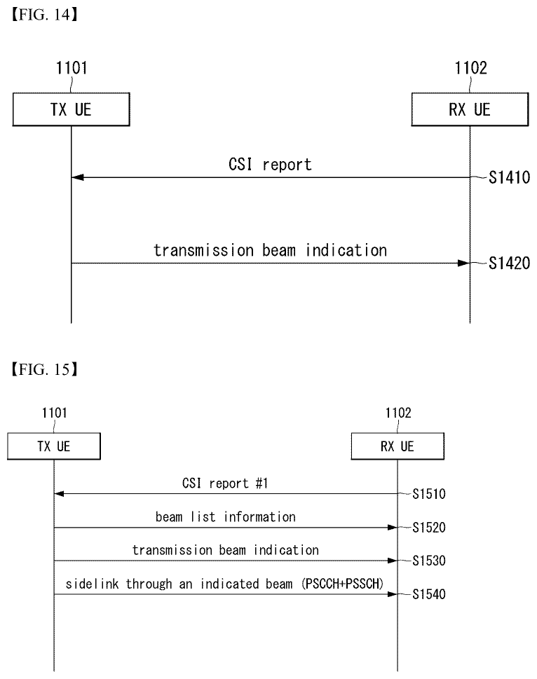

FIG. 15 is a sequence chart illustrating a third exemplary embodiment of transmission beam switching based on CSI reporting.

As shown in FIG. 15, the TX UE 1101 and the RX UE 1102 are illustrated as shown in FIGS. 13 and 14, and each of the TX UE 1101 and the RX UE 1102 may be an entity performing a procedure of FIG. 15. Each of the TX UE 1101 and RX UE 1102 shown in FIG. 15 may be a communication node located in the vehicle 100 or 110, infrastructure 120, or communication node held by the person 130, as shown in FIG. 1. Additionally, each of the TX UE 1101 and RX UE 1102 may include at least part of or all of the components described with reference to FIG. 3 or may have additional components. Furthermore, each of the TX UE 1101 and RX UE 1102 may include at least part of the components described in FIGS. 4 to 8.

Referring to FIG. 15, the procedure of the TX UE 1101 and RX UE 1102 according to the present disclosure will be described.

In step S1510, the RX UE 1102 may transmit a CSI report to the TX UE 1101 through the sidelink. Here, the CSI report may include CSI and may be transmitted using a PSSCH or a MAC-CE of the PSSCH transmitted by the RX UE 1102 to the TX UE 1101.

The transmission of the CSI report from the RX UE 1102 to the TX UE 1101 in step S1510 may mean that the TX UE 1101 has already transmitted preconfigured signals to the RX UE 1102 that enable the CSI reporting as described in FIGS. 11 to 14. In other words, prior to step S1510 in FIG. 15, the TX UE 1101 may have transmitted at least one preconfigured signal such as reference signals or SSs with S-SSB(s). Accordingly, the RX UE 1102 may transmit the CSI report based on the signals received from the TX UE 1101.

If the TX UE 1101 has transmitted preconfigured signals using multiple beams, the RX UE 1102 may report CSI for each of the multiple beams. As another example, if the TX UE 1101 has transmitted preconfigured signals using multiple beams, the RX UE 1102 may report CSI for only a beam with the highest quality. As another example, if the TX UE 1101 has transmitted preconfigured signals using multiple beams, the RX UE 1102 may transmit information on a beam with the highest quality and transmit information on a difference relative to the beam with the highest quality for each of the remaining beams.

Here, the beam with the highest quality may be determined as either a beam with the highest received signal received power (RSRP) or a beam with the highest Layer 1 (L1)-RSRP.

In step S1510, the TX UE 1101 may receive the CSI report from the RX UE 1102 through a PSSCH or a MAC-CE of the PSSCH.

The TX UE 1101 may determine whether to switch a transmission beam used for SL communication based on the CSI report received from the RX UE 1102. The TX UE 1101 may select a beam with the best BQI among the beams reported by the RX UE 1102 as a beam to be switched to. The selected beam may be either a beam currently in use for communication or a new beam. In step S1510, when the TX UE 1101 receives the CSI report, the TX UE 1101 may generate a transmission beam indication list as described in FIG. 14.

In step S1520, the TX UE 1101 may transmit the generated transmission beam indication list to the RX UE 1102 as beam list information. Accordingly, in step S1520, the RX UE 1102 may receive the transmission beam indication list from the TX UE 1101. In other words, the TX UE 1101 and RX UE 1102 may share the beam list information.

In step S1520, the TX UE 1101 may indicate a transmission beam based on the transmitted transmission beam indication list. In other words, the TX UE 1101 may indicate the transmission beam to be used for SL communication based on Table 6 described earlier. Accordingly, the RX UE 1102 may receive information on the transmission beam indicated by the TX UE 1101.

In step S1540, the TX UE 1101 may perform SL communication using the indicated beam. In other words, the TX UE 1101 may transmit SL control information through a PSCCH and SL data through a PSSCH using the indicated beam.

Meanwhile, in step S1530, when the TX UE 1101 indicates the transmission beam, the TX UE 1101 may configure a time offset. If the TX UE 1101 configures a time offset when indicating the transmission beam, in step S1540, the indicated beam may be used starting from a transmission beam transmitted after the time offset elapses. As another method for configuring the time offset, the time offset may be configured using SCI, MAC-CE, RRC, or other higher-layer signaling, or a combination of these schemes.

Configuration information of the time offset may be configured in an SL-specific or RP-specific manner, and the time offset may be indicated in time units such as the number of slots, the number of symbols, or milliseconds (ms).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first user equipment (UE), comprising:
transmitting, to a second UE, a channel state information (CSI) request requesting to report CSI;
transmitting, to the second UE, a reference signal for beam measurement through different transmission beams in respective symbols where the reference signal is transmitted within one sidelink (SL) slot;
receiving, from the second UE, a first CSI report including beam indexes based on an order of the respective symbols where the reference signal is transmitted and first CSI measurement information based on values obtained by measuring the reference signal in the respective symbols;
determining a first transmission beam to be used for SL communication based on the first CSI report; and
performing the SL communication with the second UE using the first transmission beam after a preset time offset.

2. The method according to claim 1, wherein the respective symbols where the reference signal is transmitted include symbol(s) transmitting a Physical Sidelink Shared Channel (PSSCH), or include symbol(s) transmitting the PSSCH and symbol(s) transmitting a demodulation reference signal (DMRS).

3. The method according to claim 2, wherein the reference signal transmitted through the PSSCH is a CSI-reference signal (CSI-RS).

4. The method according to claim 3, wherein when the CSI-RS is transmitted through two ports for each symbol, different beam indexes are assigned to each symbol based on port numbers.

5. The method according to claim 1, further comprising:
transmitting, to the second UE, sidelink-synchronization signal block(s) (S-SSB(s)) for CSI measurement through a plurality of beams based on the CSI request; and
receiving, from the second UE, a second CSI report including second CSI measurement information based on measurement of the S-SSB(s) and beam indexes based on a transmission order of the plurality of beams,
wherein in the determining of the first transmission beam, the first transmission beam is determined by further considering the second CSI report.

6. The method according to claim 5, further comprising: transmitting, to the second UE, information of a CSI configuration window for limiting the S-SSB(s) used for the CSI measurement based on the CSI request,
wherein the CSI configuration window is configured as a predetermined time from the SL slot.

7. The method according to claim 1, further comprising: before performing the SL communication with the second UE using the first transmission beam, transmitting transmission beam indication information indicating the first transmission beam to the second UE.

8. The method according to claim 7, wherein the transmission beam indication information is configured using a Transmission Configuration Indication (TCI) state.

9. The method according to claim 8, wherein the TCI state is indicated by a Medium Access Control-Control Element (MAC-CE) or Radio Resource Control (RRC) message transmitted by the first UE to the second UE.

10. A method of a second user equipment (UE), comprising:
receiving, from a first UE, a channel state information (CSI) request requesting to report CSI;
receiving a reference signal for beam measurement transmitted through different beams within one sidelink (SL) slot based on the CSI request;
transmitting, to the first UE, a first CSI report including beam indexes based on an order of respective symbols where the reference signal is transmitted and first CSI measurement information based on values obtained by measuring the reference signal in the respective symbols; and
performing SL communication with the first UE through a first transmission beam after a preset time offset.

11. The method according to claim 10, wherein the respective symbols where the reference signal is transmitted include symbol(s) transmitting a Physical Sidelink Shared Channel (PSSCH), or include symbol(s) transmitting the PSSCH and symbol(s) transmitting a demodulation reference signal (DMRS).

12. The method according to claim 11, wherein the reference signal transmitted through the PSSCH is a CSI-reference signal (CSI-RS).

13. The method according to claim 12, wherein when the CSI-RS is transmitted through two ports for each symbol, different beam indexes are assigned to each symbol based on port numbers.

14. The method according to claim 10, further comprising:
receiving sidelink-synchronization signal block(s) (S-SSB(s)) for CSI measurement through a plurality of beams based on the CSI request; and
transmitting, to the first UE, a second CSI report including second CSI measurement information based on measurement of the S-SSB(s) and beam indexes based on a transmission order of the plurality of beams.

15. The method according to claim 14, further comprising: receiving, from the first UE, information of a CSI configuration window for limiting the S-SSB(s) used for the CSI measurement based on the CSI request,
wherein the CSI configuration window is configured as a predetermined time from the SL slot.

16. The method according to claim 10, further comprising: before performing the SL communication using the first transmission beam, receiving transmission beam indication information indicating the first transmission beam.

17. The method according to claim 16, wherein the transmission beam indication information is configured using a Transmission Configuration Indication (TCI) state.

18. The method according to claim 17, wherein the TCI state is indicated by a Medium Access Control-Control Element (MAC-CE) or Radio Resource Control (RRC) message received from the first UE.

19. A first user equipment (UE) comprising at least one processor, wherein the at least one processor causes the first UE to perform:
transmitting, to a second UE, a channel state information (CSI) request requesting to report CSI;
transmitting, to the second UE, a reference signal for beam measurement through different transmission beams in respective symbols where the reference signal is transmitted within one sidelink (SL) slot;
receiving, from the second UE, a first CSI report including beam indexes based on an order of the respective symbols where the reference signal is transmitted and first CSI measurement information based on values obtained by measuring the reference signal in the respective symbols;
determining a first transmission beam to be used for SL communication based on the first CSI report; and
performing the SL communication with the second UE using the first transmission beam after a preset time offset.

20. The first UE according to claim 19, wherein the at least one processor causes the first UE to perform:
transmitting, to the second UE, sidelink-synchronization signal block(s) (S-SSB(s)) for CSI measurement through a plurality of beams based on the CSI request; and
receiving, from the second UE, a second CSI report including second CSI measurement information based on measurement of the S-SSB(s) and beam indexes based on a transmission order of the plurality of beams,
wherein in the determining of the first transmission beam, the first transmission beam is determined by further considering the second CSI report.
